(19) United States
(12) Patent Application Publication
(10) Pub. No.: US 2013/0262634 A1
(43) Pub. Date: Oct. 3, 2013

(54) SITUATION COMMAND SYSTEM AND OPERATING METHOD THEREOF

(71) Applicants: TSE-MING CHANG, Taipei (TW); Shih-Chia Cheng, Taipei (TW); Kai-Yin Cheng, Taipei (TW)

(72) Inventors: TSE-MING CHANG, Taipei (TW); Shih-Chia Cheng, Taipei (TW); Kai-Yin Cheng, Taipei (TW)

(73) Assignee: IKALA Interactive Media Inc., Taipei City (TW)

(21) Appl. No.: 13/459,181

(22) Filed: Apr. 28, 2012

(30) Foreign Application Priority Data
Mar. 29, 2012 (TW) 101110969

(51) Int. Cl. G06F 15/16

(52) U.S. Cl. 709/219

(57) ABSTRACT

A situation command system including a multimedia apparatus and a server is provided. The multimedia device and the server are connected via a network system. The multimedia apparatus, including a microprocessor, a memory device, a multimedia file input device, a network interface, an audio/video body-sensing input device, an audio/video body-sensing output device and a control device, presents a multimedia effect of a file to a user. The server, including a central processing system, a storage system, a communication system and a recognition system, accesses the file and determines whether the file satisfies a trigger condition to selectively output a special effect. When the file satisfies the trigger condition, the multimedia apparatus further superimposes the special effect to the file and presents the file together with the special effect to the user to provide a situation simulation effect.

### BACKGROUND OF THE INVENTION

1. Field of the Invention

The invention relates in general to a situation simulation system, and more particularly to a situation simulation command system for an entertainment activity and an operating method thereof.

2. Description of the Related Art

Common entertainment activities are targeted at rendering people with sensational satisfactions. To provide visual and audio stimulations, popular entertainment activities include video games, movies and karaoke. A karaoke system prompts a user to sing a correspondingly song through audio and video playback, and is one of the most prevalent entertainment options.

Further, a current karaoke system supports a mode in which a user-requested special effect may be simultaneously played along with an original melody and a music video of a song while singing the song. For example, when a user wishes to experience senses of singing in a concert, a concert hall effect may be selected through a remote controller so that the system provides simulations of singing in a concert held in a concert hall. Alternatively, when a user is pleased with his singing, an applause effect may also be selected so that the system automatically plays an applause effect. Or, to celebrate a user birthday, a birthday cake effect may be selected so that the system displays a birthday cake on a monitor. Thus, situation simulations are provided by the karaoke system during singing to enhance entertainment results.

However, with all the special effect options provided by a karaoke system, the desired special effect can only be presented when the desired special effect is manually selected by the user. Such approach is considered as a passive interaction and the user is in advance aware of the coming special effect, such that simulation and entertainment results may be depreciated.

Therefore, in the hope that individuals who are stressed in the daily life may be offered with thorough amusements and relaxations, the disclosure is directed at a solution for enhancing entertainment and simulation results.

### SUMMARY OF THE INVENTION

The disclosure provides a situation command system comprising a multimedia apparatus and a server. The multimedia apparatus and the server are connected via a network system. Through the network system, file transmissions between the multimedia apparatus and the server can performed and resources on the network system may also be acquired.

The multimedia apparatus comprises a microprocessor, a memory device, a multimedia file input device, a network interface, an audio/video body-sensing input device, an audio/video body-sensing output device and a control device. For example, the multimedia apparatus is a multimedia apparatus connectable to a network, such as a network television, a mobile phone, a tablet computer, a personal computer, an electronic game console or a portable video/audio playback device for providing video, audio and body-sensing effects to a user.

The microprocessor is connected to the memory device, the multimedia file input device, the network interface, the audio/video body-sensing input device, the audio/video body-sensing output device and the control device. The microprocessor is in charge of controlling operations of the devices in the multimedia apparatus.

The memory device is connected to the microprocessor and the multimedia file input device. The memory device is for storing files for the multimedia apparatus, which then can access the files from the memory device for playback.

The multimedia file input device is connected to the microprocessor, the memory device and the network interface. The multimedia file input device allows a user to input files to the multimedia apparatus, and transmits the inputted files to the memory device for storage. For example, the multimedia file input device is an optical disc drive, a floppy disc drive, a USB portable disc, a keyboard or a mouse for inputting files.

The network interface is connected to the microprocessor and the multimedia file input device. The network interface is for connecting to the network system, and is capable of inputting files to the multimedia apparatus via the network system as well as outputting files for the access of the server.

The audio/video body-sensing input device is connected to the microprocessor. The audio/video body-sensing input device detects user images, sounds, gestures and actions, and inputs the detected user images, sounds, gestures and actions to the multimedia apparatus. For example, the audio/video body-sensing input device is a video camera, a digital camera, a microphone or a body-sensing detector for detecting user behaviors.

The audio/video body-sensing output device is connected to the microprocessor. The audio/video body-sensing output device presents video, audio and body-sensing effects to a user. For example, the audio/video body-sensing output device is a speaker, a monitor, a projector, a force-feedback joystick, a vibration handle capable of presenting video, audio and body-sensing effects.

The control device is connected to the microprocessor. The control device allows a user to input operation commands to the microprocessor to control operations of the multimedia apparatus.

The server comprises a central processing system, a storage system, a communication system and a recognition system. The server is principally for detecting a user-inputted file and generating a corresponding response to the multimedia apparatus.

The central processing system is connected to the storage system, the communication system and the recognition system. The central processing system is for controlling operations of the systems in the server, and comprises an identification verification module. The identification verification module is connected to the communication system and the storage system, and is for determining a user identification.

The storage system, the central processing system and the communication system are connected to one another. The storage system stores at least one trigger condition and at least one special effect. For example, the at least one trigger condition is a predetermined word, a predetermined pronunciation, a predetermined tone, a predetermined rhythm, a predetermined sound volume, a predetermined timbre, a predetermined color, a predetermined brightness, a predetermined graphic, a predetermined gesture, a predetermined action and/or the combination thereof. For example, the at least one special effect is a predetermined visual effect, a predetermined audio effect, a predetermined touch effect, and/or the combination thereof.

Storage content in the storage system is categorized into predetermined storage content and customized storage content. The predetermined storage content is for the use of unregistered users, whereas the customized content is for the use of registered users. Further, the customized content is user-editable and may thus vary for different users. That is, for different user identifications, the at least one trigger condition and the at least one special effect may correspondingly be different.

The communication system is for connecting to the network system, so as to allow the server to access files via the communication system and to output the at least special effect stored in the storage system.

The identification system is connected to the central processing system, the storage system and the communication system. The identification system determines whether the content of an accessed file satisfies the at least one trigger condition. The accessed file is not limited to a file provided by the multimedia apparatus or the memory device, and may include a file converted from user images, sounds and actions by the audio/video body-sensing input device.

The recognition system comprises a recognition controller, a text recognition module, an audio recognition module, a video recognition module and a body-sensing recognition module. The recognition controller is connected to the text recognition module, the audio recognition module, the video recognition module and the body-sensing recognition module. The recognition controller is for controlling operations of the recognition system. The text recognition module is for recognizing text content of a file. The audio recognition module is for recognizing audio content of a file, e.g., a pronunciation, a tone, a rhythm, a sound volume and a timbre. The video recognition module is for recognizing video content of a file, e.g., a color, brightness and a graphic. The body-sensing recognition module is for recognizing body-sensing content of a file, e.g., a gesture and an action. The recognition approach of the recognition system for the file content may be an exact match and/or a partial match.

The disclosure further provides an operating method of a situation command system. The operating method comprises steps of: connecting to a server; logging into a server by a multimedia apparatus for identification verification; accessing by the server a file outputted from the multimedia apparatus; comparing whether the content of the file matches customized at least one trigger condition; outputting triggered customized at least one special effect; and presenting an actual effect of the triggered customized at least one special effect.

The disclosure yet provides an operating method of a situation command system. The operating method comprises steps of: connecting to a server; accessing by the server a file outputted from a multimedia apparatus; comparing whether content of the accessed file satisfies predetermined at least one condition; outputting triggered predetermined at least one special effect; and presenting an actual effect of the triggered predetermined at least one special effect.

A main difference between the two operating methods above is the step of user logging in. When the step of user logging in is included, the customized content may be used by the registered user identification, or else the predetermined content is used.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a situation command system according to one embodiment.

FIG. 2 is a flowchart of an operating method of a situation command system according to one embodiment.

FIG. 3 is a flowchart of an operating method of a situation command according to an alternative embodiment.

### DETAILED DESCRIPTION OF THE INVENTION

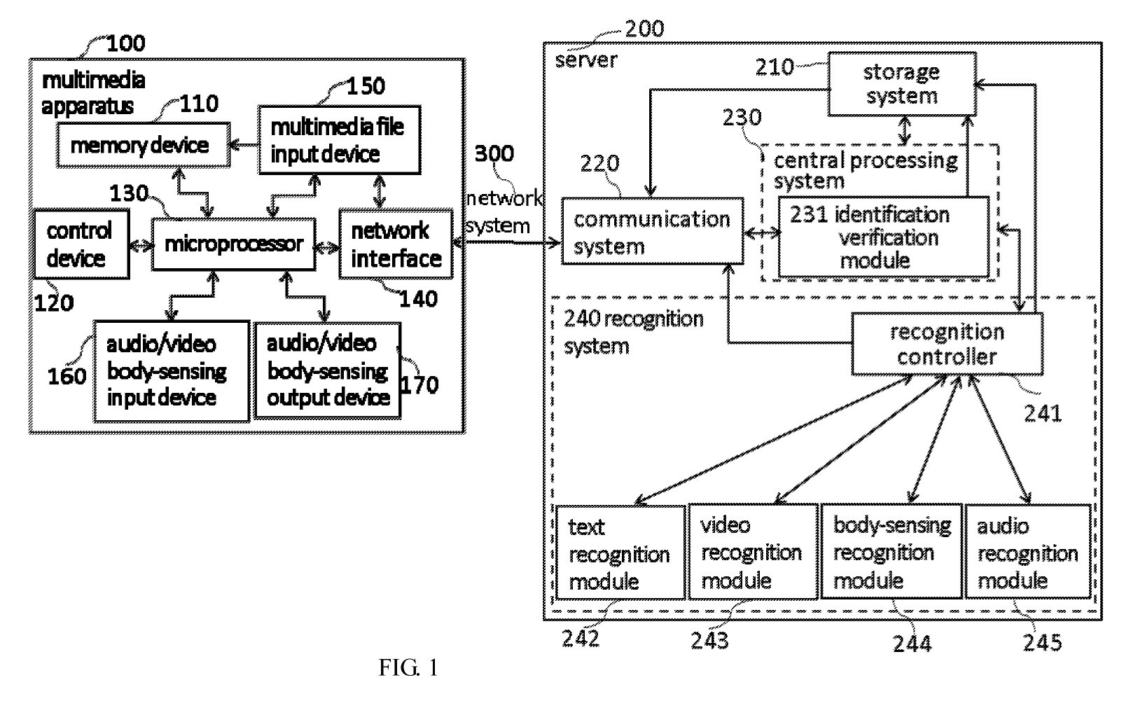

FIG. 1 shows a block diagram of a situation command system according to one embodiment of the present invention. Referring to FIG. 1, a situation command system comprises a multimedia apparatus 100 and a server 200. The multimedia apparatus 100 and the server 200 are connected via a network system 300. The multimedia apparatus 100 is usually implemented at a user end to offer a main function of presenting audio/video body-sensing services to a user. The server 200 is usually implemented at a service provider end to mainly examine a user-inputted file and to output a corresponding response to the multimedia apparatus 100.

The multimedia apparatus 100 comprises a microprocessor 130, a memory device 110, a multimedia file input device 150, a network interface 140, an audio/video body-sensing input device 160, an audio/video body-sensing output device 170, and a control device 120.

The microprocessor 130 is connected to the memory device 110, the multimedia file input device 150, the network interface 140, the audio/video body-sensing input device 160, the audio/video body-sensing output device 170 and the control device 120. The microprocessor 130 controls operations of the devices in the multimedia apparatus 100.

The memory device 110, connected to the microprocessor 130 and the multimedia file input device, is for storing a file.

The multimedia file input device 150, connected to the microprocessor 130, the memory device 110 and the network interface 140, allows a user to input a file.

The network interface 140, connected to the microprocessor 130 and the multimedia file input device 150, is for connecting to the network system 300 to connect to resources on the server 200 and the network system 300.

The audio/video body-sensing input device 160 is connected to the microprocessor 130. The audio/video body-sensing device 160 detects a current user status and outputs the detected user status to the multimedia apparatus 100, so as to sense a user image, a user sound and a user action.

The audio/video body-sensing output device 170, connected to the microprocessor 130, presents video, audio and body-sensing effects to a user.

The control device 120, connected to the microprocessor 130, allows a user to input a command for controlling the multimedia apparatus 100.

The server 200 comprises a central processing system 230, a storage system 210, a communication system 220 and a recognition system 240.

The central processing system 230, connected to the storage system 210, the communication system 220 and the recognition system 240, controls operations of the systems in the server 200. The central processing system 230 comprises an identification verification module 231, which is connected to the communication system 220 and the storage system 210. When the multimedia apparatus 100 logs into the server via the network system 300, the identification module 231 determines a logged user identification, and the storage system 210 then provides customized content or predetermined content according to the logged-in user identification.

The storage system 210, connected to the central processing system 230, the communication system 220 and the recognition system 240, stores at least one trigger condition and at least one special effect.

Storage content in the storage system 210 is categorized into predetermined content and customized content. The predetermined content is for the use of unregistered users, whereas the customized content is for the use of registered users. Further, the customized content is user-editable and may thus vary for different users. Moreover, according to the using behavior of a user, the customized content can also be adjusted automatically. That further provides services based on customization. That is, for different user identifications, the at least one trigger condition and the at least one special effect may correspondingly be different. For example, for a snow effect, a shape, a size and an density of snowflakes may be user-defined, and the at least one trigger condition may be changed from an initial setting of a word “snow” appearing in a subtitle to a user-updated word “cold” in the subtitle or word “chill” is sung. The customized content also can be adjusted to user's behavior by the situation command system automatically.

The communication system 220 is connected to the central processing system 230, the storage system 210 and the recognition system 240. The communication system 220 is for connecting to the network system 300 to maintain the connection with the multimedia apparatus 100.

The recognition system 240, connected to the central processing system 230, the storage system 210 and the communication system 220, determines whether the file content accessed by the server 200 satisfies the at least one trigger condition. The recognition system 240 comprises a recognition controller 241, a text recognition module 242, an audio recognition module 245, a video recognition module 243 and a body-sensing recognition module 244. The recognition controller 241 controls operations of the recognition system 240, and the remaining recognition modules are for handling different types of recognitions. The text recognition module 242 is for recognizing text content in the file. The audio recognition module 245 is for recognizing audio content in the file, e.g., a pronunciation, a tone, a rhythm, a sound volume and a timbre. The video recognition module 243 is for recognizing video content in the file, e.g., a color, a brightness and a graphic. The body-sensing recognition module 244 is for recognizing body-sensing content in the file, e.g., a gesture and an action.

Through the multimedia apparatus 100, various user statuses may be detected. The detected user statuses are provided to the server 200 for further determination, so that the at least one special effect may be correspondingly outputted in response to the user statuses. Compared to the prior art in which a special effect needs to be manually selected by a user, the situation command system of the disclosure is capable of determining how to simulate a user desired situation to prevent the issue of the lack of a fresh feeling in predictable special effects. With the audio/video body-sensing output device 160 in the multimedia apparatus 100, characteristics of a current user status may be collectively gathered from visual, audio and touching perspectives. Based on the characteristics, the recognition system 240 in the server 200 is able to precisely determine current user-desired stimulations to correspondingly output a desired special effect. The multimedia apparatus 100 then presents the at least one special effect together with the original content to a user. Therefore, through the approach of generating a response with coordination of user statuses, it is in equivalence that the situation command system of the disclosure is capable of actively interacting with a user to authentically achieve realistic situation simulation effects.

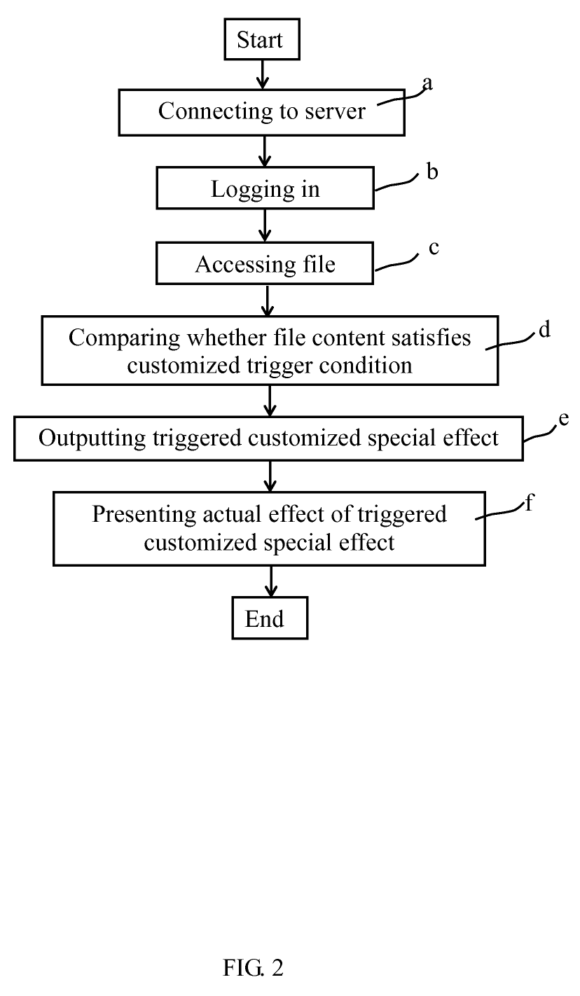

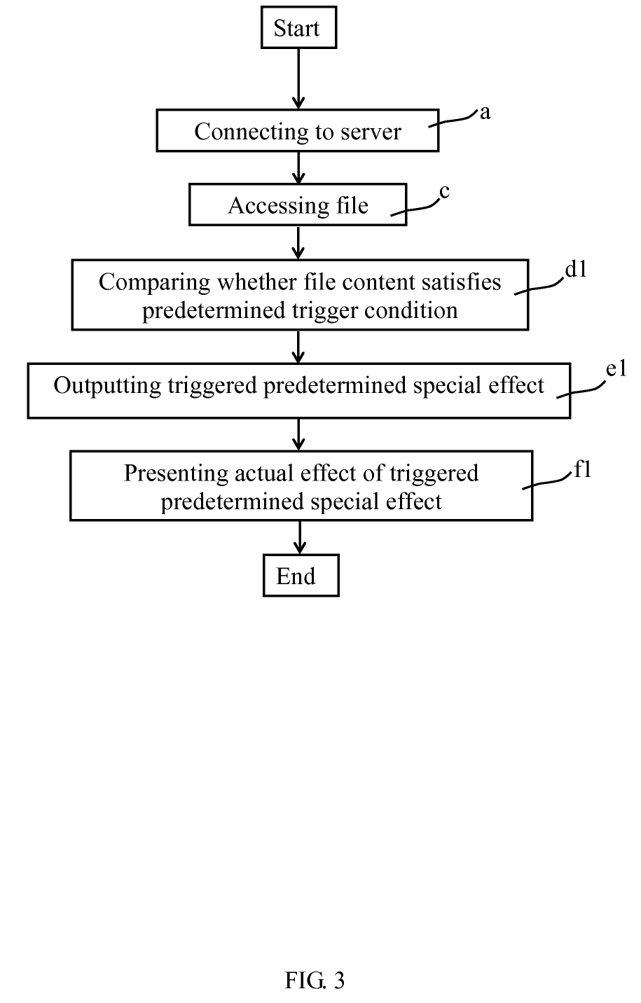

In the description below, an operating method of a situation command system shall be given with reference to FIGS. 2 and 3 by taking karaoke as an example. FIGS. 2 and 3 respectively show a flowchart of an operating method according to two embodiments. A main difference between the processes in FIGS. 2 and 3 is whether a logging in step is included the process in FIG. 2 comprises a logging in step whereas the process in FIG. 3 does not comprise the logging in step. In Step (a), a connection with the server 200 is established. More specifically, the multimedia apparatus 100 is connected to the network system 300 to further connect to the server 200.

Next, the identification verification module 231 verifies a user identification to determine whether the user is a registered user. This is the point that distinguishes the processes in FIGS. 2 and 3. When the registered user is logged in, Step (b) in FIG. 2 is performed, in which the customized content is utilized according to the verified user identification. When the user is not logged in, the predetermined content is provided as Step (c) in FIG. 3. In subsequent steps, the at least one special effect and the at least one trigger condition are customized when the logging in step is performed, or else are predetermined when the logging in step is not performed, with remaining details of the processes in FIGS. 2 and 3 being the same. In the description below and in FIG. 3, steps denoted with a numeric “1”, e.g., Step (d1), Step (e1) and Step (f1) indicate that the predetermined at least one special effect and the predetermined at least one trigger condition are utilized. The process with a logging in step is to be described in continuation with reference to FIG. 2.

After the logging in step, Step (c) is performed. In Step (c), a user-inputted file is received by the multimedia apparatus 100, or a file to be executed is selected from the memory device 110 in the multimedia apparatus 100. This is step is the so-called “song request”. The multimedia apparatus 100 then starts to play the file (i.e., a music video of the requested song) selected by the user, and the user starts to sing with guidance provided by the music video. Next, the video/audio body-sensing input device 160 in the multimedia apparatus 100 starts to detect images, sounds and actions, and meanwhile the server 200 also accesses the file via the network system 300.

The method proceeds to Step (d) after the server 200 accesses the file. The recognition system 240 in the server 200 determines whether content of the file satisfies the customized at least one trigger condition stored in the storage system 210. For example, the customized at least one trigger condition is when a predetermined word “lonely” appears in the music video, a predetermined pronunciation “travel” is sung by the user, a predetermined graphic “the sun” appears in the music video, or a predetermined action “jumping” is performed by the user. The matching approach may be an exact match and/or a partial match.

In Step (e), the server 200 outputs the customized at least one special effect in the storage system 210 to the multimedia apparatus 100. For example, the customized at least one special effect is a special visual effect of “glittering”, a special audio effect of “applause” or a special touch effect of “vibration”.

In Step (f), the multimedia apparatus 100 presents the customized at least one special effect together with original content of the file to the user.

Regardless of whether the content is customized or predetermined, the triggered at least one condition may be a plurality of conditions. Accordingly, a corresponding special effect is only generated when at least two conditions are satisfied. For example, the plurality of conditions is the word “rain” is sung at a tone “of over 400 Hz”. The at least one special effect may also be a plurality of special effects. For example, when a user sound volume exceeds 90 decibels, special effects of a shaking image on the monitor and a vibrated microphone are simultaneously presented by the situation command system.

The at least one special effect corresponds to the at least one trigger condition for a corresponding effect. For example, when a music video is played based on a user song request, an image of “raindrops falling” appears on the monitor as the word “rain” appears in the music video, a sound of applause is played by the speaker as the tone of the user reaches “over 400 Hz” when singing the chorus, a guitar score of a guitar solo is displayed by the monitor as the song enters the guitar solo and a graphic “guitar” appears in the music video, the microphone vigorously vibrates as “loud drumming” appears in the content of the music video, and the image of the music video shakes as the user “jumps” during the song.

Through the operations of the situation command system of the disclosure, a user is given various interactions with the system. A corresponding special effect is generated along with a user-inputted file, a user action and a user sound, and the special effect is presented while singing a requested song. Further, the outputted special effect is a real-time special effect reflecting a current mood of the user and characteristics of the requested song rather a predictable special effect, so that the situation simulation is more realistic for enhanced entertainment results.

It should be noted that the example of karaoke is taken as an example for explaining the operations of the present invention rather than limiting the present invention thereto. For example, the operating method is also applicable to other devices connectable to the server for games, televisions, video playback, commercials, digital program broadcasting and playback of files uploaded to or downloaded from the Internet to provide active interactions for enhancing entertainment or situation simulation results. Further, through different special effect combinations, information or commercial effects may also be provided to a user. With the embodiments above, it is illustrated that the disclosure is capable of providing better simulation effects compared to the prior art.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A situation command system, comprising a multimedia apparatus and a server, the multimedia apparatus being connected to the server via a network system;
wherein, the multimedia apparatus comprises:
a microprocessor;
a memory device, connected to the microprocessor, for storing a file;
a multimedia file input device, connected to the microprocessor and the memory device, for allowing a user to input a file and transmitting the file to the memory device for storage;
a network interface, connected to the microprocessor and the multimedia file input device, for connecting to the network system, inputting the file to the multimedia apparatus via the network system, and outputting the file for the server to access;
an audio/video body-sensing input device, connected to the microprocessor, for detecting an image, a sound and an action;
an audio/video body-sensing output device, connected to the microprocessor, for representing a video, audio and body-sensing effect; and
a control device, connected to the microprocessor, for inputting an operation command to the microprocessor; and
the server comprises:
a central processing system;
a storage system, connected to the central processing system, for storing at least one trigger condition and at least one special effect;
a communication system, connected to the central processing system and the storage system, for connecting to the network system, accessing the file via the network system and outputting the at least one special effect stored in the storage system; and
a recognition system, connected to the central processing system, the storage system and the communication system, for determining whether content of the accessed file satisfies the at least one trigger condition.

2. The situation command system according to claim 1, wherein the multimedia apparatus is a network television, a mobile phone, a tablet computer, a personal computer, an electronic game console, or a portable audio/video playback apparatus.

3. The situation command system according to claim 1, wherein the multimedia file input device is an optical disc drive, a floppy disc drive, a USB portable disc, a keyboard or a mouse.

4. The situation command system according to claim 1, wherein the audio/video body-sensing input device is a video camera, a digital camera, a microphone or a body-sensing detector.

5. The situation command system according to claim 1, wherein the audio/video output device is a speaker, a monitor, a projector, a force-feedback joystick or a vibration handle.

6. The situation command system according to claim 1, wherein the central processing system comprises:
an identification module, connected to the storage system and the communication system, for determining a logged user identification.

7. The situation command system according to claim 1, wherein the recognition system comprises:
a recognition controller, connected to the central processing system, the storage system and communication system, for controlling operations of the recognition system;
a text recognition module, connected to the recognition controller, for recognizing a text in the file;
an audio recognition module, connected to the recognition controller, for recognizing a pronunciation, a tone, a rhythm, a sound volume and a timbre in the file;
a video recognition module, connected to the recognition controller, for recognizing a color, a brightness and a graphic in the file; and
a body-sensing recognition module, connected to the recognition controller, for recognizing a gesture and an action in the file.

8. The situation command system according to claim 1, wherein the at least one trigger condition is a predetermined word, a predetermined pronunciation, a predetermined tone, a predetermined rhythm, a predetermined sound volume, a predetermined timbre, a predetermined color, a predetermined brightness, a predetermined graphic, a predetermined gesture, and/or a predetermined action and the combination thereof.

9. The situation command system according to claim 1, wherein the at least one special effect is a predetermined visual effect, a predetermined audio effect, and/or a predetermined touch effect and the combination thereof.

10. An operating method of a situation command system, comprising:
a) connecting to server;
b) logging by a multimedia apparatus into a server for identification verification;
c) accessing by the server a file outputted from the multimedia apparatus;
d) comparing whether content of the file satisfies customized at least one trigger condition;
e) outputting triggered customized at least one special effect; and
f) presenting an actual effect of the triggered customized at least one special effect.

11. The operating method according to claim 10, wherein step (d) determines whether the at least one trigger condition is satisfied according to an exact match and/or a partial match.

12. The operating method according to claim 10, wherein the at least one trigger condition in step (d) is a predetermined word, a predetermined pronunciation, a predetermined tone, a predetermined rhythm, a predetermined sound volume, a predetermined timbre, a predetermined color, a predetermined brightness, a predetermined graphic, a predetermined gesture, and/or a predetermined action and the combination thereof.

13. The operating method according to claim 10, wherein the at least one special effect in step (e) is a predetermined visual effect, a predetermined audio effect, and/or a predetermined touch effect and the combination thereof.

14. The operating method according to claim 10, wherein the triggered at least one special effect in step (f) is directly superimposed on the content of the file, and is presented to a user together with the content of the file.

15. An operating method of a situation command system, comprising:
a) connecting to server;
c) accessing by the server a file outputted from the multimedia apparatus;
d1) comparing whether content of the file satisfies predetermined at least one trigger condition;
e1) outputting triggered predetermined at least one special effect; and
f1) presenting an actual effect of the triggered predetermined at least one special effect.

16. The operating method according to claim 15, wherein step (d1) determines whether the at least one trigger condition is satisfied according to an exact match and/or a partial match.

17. The operating method according to claim 15, wherein the at least one trigger condition in step (d1) is a predetermined word, a predetermined pronunciation, a predetermined tone, a predetermined rhythm, a predetermined sound volume, a predetermined timbre, a predetermined color, a predetermined brightness, a predetermined graphic, a predetermined gesture, and/or a predetermined action and the combination thereof.

18. The operating method according to claim 15, wherein the at least one special effect in step (e1) is a predetermined visual effect, a predetermined audio effect, and/or a predetermined touch effect and the combination thereof.

19. The operating method according to claim 15, wherein the triggered at least one special effect in step (f1) is directly superimposed on the content of the file, and is presented to a user together with the content of the file.
